(19) United States
(12) Patent Application Publication
(10) Pub. No.: US 2012/0286758 A1
(43) Pub. Date: Nov. 15, 2012

(54) Controller

(76) Inventors: Yen-Wei Hsu, Taipei (TW); Whei-Chyou Wu, Fremont, CA (US)

(21) Appl. No.: 13/103,114

(22) Filed: May 9, 2011

(51) Int. Cl. G05F 5/02

(52) U.S. Cl. 323/300

(57) ABSTRACT

This invention relates to a controller, more particularly, to a controller for driving a power transistor for obtaining improving impedance matching. An embodiment of a flow chart is revealed for the operation of the controller. The controller has frequency modulation capability with Lenz current of a loop linking to the driven power transistor to function with, Miller effect cancelling capability to its driven power transistor and fault detecting capability by detecting the absence of a Lenz current of a loop linking to the driven power transistor to function with.

### FIELD OF INVENTION

This invention relates to a controller, more particularly, to a controller for driving a power transistor for obtaining improving impedance matching. An embodiment of a flow chart is revealed for the operation of the controller. The controller has frequency modulation capability with Lenz current of a loop linking to the driven power transistor to function with, Miller effect cancelling capability to its driven power transistor and fault detecting capability by detecting the absence of a Lenz current of a loop linking to the driven power transistor to function with.

### BACKGROUND INFORMATION

It has been known that one important application of a PWM controller is for controlling the on/off switchings of a power transistor.

FIG. 4 has shown a power transistor network which contains a first power transistor 401, a second power transistor 402 and a third power transistor 403 respectively controlled by a PWM controller 404 of which the first power transistor 401 and the second power transistor 402 are electrically connected in series and the third power transistor 403 is electrically connected in parallel with the first power transistor 401 and the second power transistor 402. The power transistor network tries to present both the parallel and serial connections among the three power transistors. FIG. 4 has also shown a loop linking to the power transistor network to function with. The loop tries to be expressed in a general form containing a power source 406, a loading 405 and the power transistor network electrically connected in series with each other.

A PWM controller 404 outputs a waveform containing a baseband 4041 and a carrier 4042 modulated with the baseband 4041 for controlling the alternating on/off switchings of each power transistor. For the purpose of convenience, an “on” of the power transistor expresses the driving current from the power source 406 flowing through the power transistor and an “off” of the power transistor expresses the driving current from the power source 406 is cut off at the power transistor.

When an “on” of each power transistor, a driving current from the power source 406 flows through the loop and an “off” after the previous “on” of each power transistor forms a cut-open point at the power transistor resulting in the cut-off of the driving current from the power source 406 in the loop and the formation of a Lenz current at the cut-open point opposite to its driving current from the power source 403. As long as there is an “action”, there is a “reaction” to the “action”. Lenz current is a “reaction”, a system responding signal not a given signal, to an “action”, the driving current from the power source 406 of the loop. The system responding signal “Lenz current” contains the frequency responses of the loop including that of the loading 405 and the three power transistors 401, 402 and 403 shown in FIG. 4 and the phase difference between the Lenz current and its opposite driving current is 180°.

The input capacitance of a power transistor will be amplified by the power transistor, which is known as Miller effect. A very small gate capacitance of power transistor decides a very big electrical power to flow through the power transistor such as MOS power transistor, which reflects the importance of the Miller effect. Further, the discrepencies exist among the three power transistors shown in FIG. 4 so that the three power transistors are hard to be turned “on” or “off” at the same time.

If the frequency response of the loop including that of the loading 405 and the three power transistors brought by Lenz current can be modulated with the baseband of the PWM controller 404 and copied into the loop by the three power transistors, then a better impedance matchings between the PWM controller 404 and its driven power transistors can be obtained, in other words, the benefits brought by the matching are: (1) the three power transistors can easier find their respective matching points in the waveform sent by the PWM controller 404, (2) the on/off switchings of the three power transistors will be more likely to follow the waveform sent by the PWM controller 401, (3) the power transistor will consume less power, (4) more accurate control to the on/off switchings of the power transistor can be obtained and (5) the Miller effect can be cancelled.

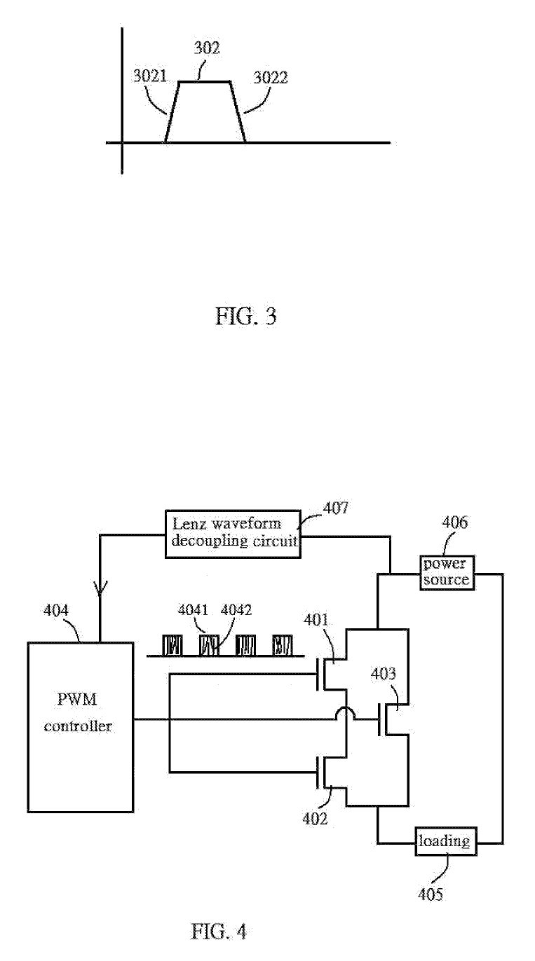

For example, if a square baseband 4041 and a carrier 4042 modulated with the baseband 4041 is output by the PWM controller 404 as shown in FIG. 4 and if the carrier 4042 is a “given” high-frequency waveform nothing to do with the loop as done by the conventional PWM controller, then the waveform responded by each power transistor will be like a waveform 302 shown in FIG. 3 with a slope with both “on” 3021 and “off” 3022 due to the unmatching and Miller effect. If the carrier 4042 modulated with the baseband 4041 shown in FIG. 4 is Lenz waveform, then a better matching can be obtained between the PWM controller and its driven power transistor and the waveform responded by each power transistor will be almost the same to the waveform sent by the PWM controller.

The Lenz current waveform can be decoupled from the loop linking to the three power transistors to function with. FIG. 4 has shown a “Lenz waveform decoupling circuit” for decoupling the Lenz waveform from the loop into the PWM controller 404. The “Lenz waveform decoupling circuit” will be revealed in our later invention.

The present invention has provided two controllers, a first controller with one output for controlling one power transistor and a second controller with two outputs for respectively controlling two power transistors, for having frequency modulation capability with Lenz current of a loop linking to the driven power transistor to function with for improving matching, having Miller effect cancelling capability to its driven power transistor and having fault detecting capability by detecting the absence of a Lenz current of a loop linking to the driven power transistor to function with, which will be more detailedly revealed in the following “detailed description of the invention”. The controllers in the present invention have also characterized both the frequency modulation capability and the phase modulation capability.

### SUMMARY OF THE INVENTION

It's a first objective to provide a first controller with one output for driving one power transistor having frequency modulation capability with Lenz current of a loop linking to the driven power transistor to function with.

It's a second objective to provide a second controller with two outputs for driving two power transistors having frequency modulation capability with Lenz current of a loop linking to the driven power transistors to function with.

It's a third objective to provide a first controller with one output for driving one power transistor having both the frequency modulation and the phase modulation capabilities.

It's a fourth objective to provide a second controller with two outputs for respectively driving two power transistors having both the frequency modulation and the phase modulation capabilities.

It's a fifth objective to provide a first controller with one output for driving one power transistor having fault detecting capability by detecting the absence of a Lenz current of a loop linking to the driven power transistor to function with.

It's a sixth objective to provide a second controller with two outputs for driving two power transistors having fault detecting capability by detecting the absence of a Lenz current of a loop linking to the driven power transistors to function with.

It's a seventh objective to provide a first controller with one output for driving one power transistor having Miller effect cancelling capability to its driven power transistor.

It's an eighth objective to provide a second controller with two outputs for respectively driving two power transistors having Miller effect cancelling capability to its driven power transistors.

### BRIEF DESCRIPTION OF THE DRAWINS

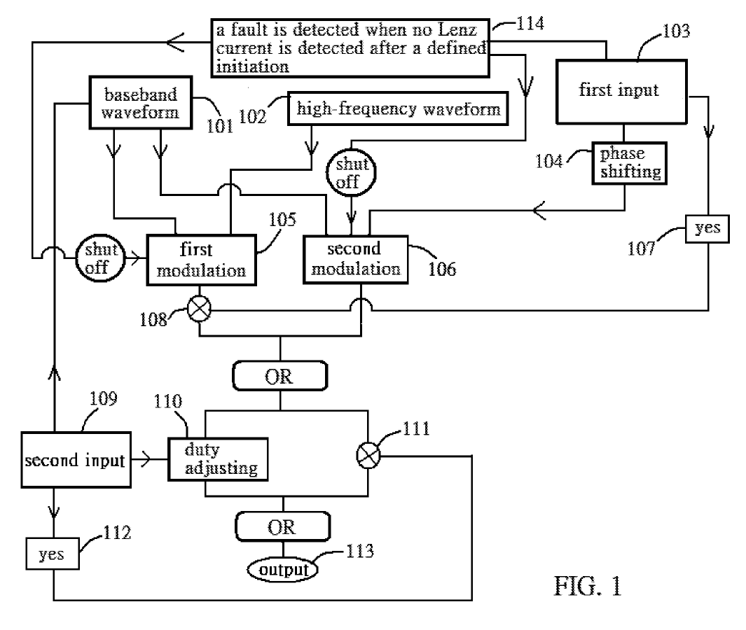

FIG. 1 has shown an embodiment of a first flow chart describing the operation of a first controller for controlling one power transistor;

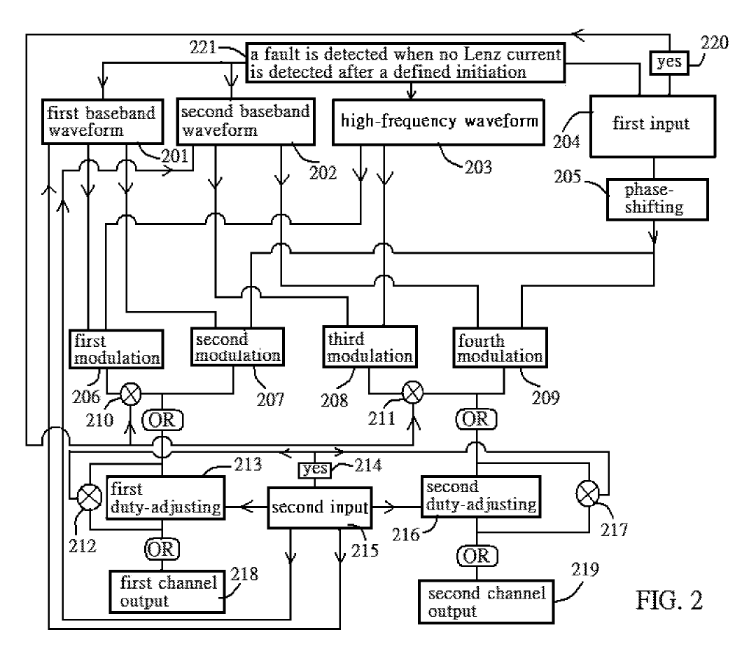

FIG. 2 has shown an embodiment of a second flow chart describing the operation of a second controller for controlling two power transistors;

FIG. 3 has shown an unmatching case of a waveform on a power transistor; and

FIG. 4 has shown a loop in a general form containing a power source, a loading and a power transistor network electrically connected in series with each other of which the power transistor network contains a first power transistor, a second power transistor and a third power transistor of which the first power transistor and the second power transistor are electrically in series and the third power transistor is in parallel with the first power transistor and the second power transistor.

### DETAILED DESCRIPTION OF THE INVENTION

A first controller for driving a power transistor is operated by a first flow chart shown by a first embodiment of FIG. 1 and a second controller for driving two power transistors is operated by a second flow chart shown by a second embodiment of FIG. 2. The two controllers are based on a same concept but with different numbers of outputs.

### The First Controller

A first controller for driving a power transistor is operated by steps shown by a flow chart in FIG. 1. For m≧1 and m=1 stands for the first round. A m^{th} baseband waveform and a m^{th} high-frequency waveform modulate together shown by a first modulation 105 in FIG. 1. The frequency of the high-frequency waveform is distinguishingly higher than that of the baseband waveform. A first input 103 is phase-shifted shown by a phase shifting 104 in FIG. 1. The m^{th} high-frequency waveform and the first input 103 after the phase shifting 104 modulate together shown by a second modulation 106. With the presence of the first input 103, the modulated waveform after the first modulation 105 is blocked against outputting shown by a first switch 108 in FIG. 1. A first “yes” 107 indicates the presence of the first input 103 is found.

A second input 109 is used to duty-adjust the modulated waveform either after the first modulation 105 or the second modulation 106 shown by a duty adjusting 110 and the second input 109 is also used to adjust or stop generating a next baseband waveform, which is a m+1^{th} baseband waveform. To stop generating the m+1^{th} baseband waveform aims to shut down the first controller.

Without the presence of the second input 109, the modulated waveform either after the first modulation 105 or the second modulation 106 is output as a m^{th} output 113 for driving the power transistor.

With the presence of the second input 109, the modulated waveform either after the first modulation 105 or the second modulation 106 is blocked against outputting by a second switch 111 and the modulated waveform either after the first modulation 105 or the second modulation 106 after the duty adjusting 110 is output as a m^{th} output 113 for driving the power transistor. A second “yes” 112 indicates the presence of the second input 109. The first controller for driving a power transistor has characterized that the first input 103 is a Lenz current of a loop linking to its driven power transistor to function with. Obviously, the Lenz current is a system responding signal not a “given” signal.

Lenz current is a system responding signal, a reaction to its driving current, so that it should be there as long as the system functions normally. A fault can be detected if at any time an absence of the Lenz current is detected after a defined initiation of the first controller. When a fault is found, immediately shut down the operation of the first controller for the consideration of safety by shutting off either the baseband waveform 101 and the high-frequency waveform 102 or shutting off the first modulation 105 and the second modulation 106. FIG. 1 has shown a “a fault is detected when no Lenz current is detected after a defined initiation” 114 to shut off the first modulation 105 and the second modulation 106 aiming to shut down the operation of the first controller. The defined initiation is not limited, for example, it can be defined as a certain number running rounds of the flow chart shown in FIG. 1. The first controller for driving a power transistor has also revealed a fault detection technique by detecting the absence of Lenz current decoupled from the loop linking to the power transistor to function with.

The phase in the phase shifting 104 is not limited, for example, it ranges between 0° and 360°. With the presence of the Lenz current input, the Lenz current is 180° phase-shifted by the phase-shifting 104 before being sent into the second modulation 106.

The second input 111 is not limited, for example, it can be a signal from a sensor such as temperature sensor, voltage sensor, current sensor or chemical sensor, etc., a signal from an emergency procedure such as a “stop” command, a signal from a manual control such as a control manipulated by hand or foot or a control by a software.

### The Second Controller

The first controller has one baseband waveform and one output. A second controller is based on the same concept as the first controller but with two basebands and two outputs.

The second controller for driving a first power transistor and a second power transistor is operated by steps shown by an embodiment of a flow chart in FIG. 2. For m≧1 and m=1 stands for the initial round. A first input 204 is phase-shifted shown by a phase shifting 205 in FIG. 2. A m^{th} first baseband waveform 201 and a m^{th} high-frequency waveform 203 modulate together shown by a first modulation 206 in FIG. 2. A m^{th} first baseband waveform 201 and the first input 204 after the phase-shifting 205 modulate together shown by a second modulation 207. A m^{th} second baseband waveform 202 and a m^{th} high-frequency waveform 203 modulate together shown by a third modulation 208. A m^{th} second baseband waveform 202 and the first input 204 after the phase-shifting 205 modulate together shown by a fourth modulation 209.

With the presence of the first input 204, the modulated waveform after the first modulation 206 is blocked against outputting shown by a first switch 210 and the modulated waveform after the third modulation 208 is blocked against outputting shown by a second switch 211 in FIG. 2. A first “yes” 220 indicates the presence of the first input 204.

A second input 215 is used to duty-adjust the modulated waveform either after the first modulation 206 or the second modulation 207 shown by a first dutyadjusting 213 and the modulated waveform either after the third modulation 208 or the fourth modulation 209 shown by a second duty-adjusting 216, and the second input 215 is also used to adjust or stop generating a next first baseband waveform and a next second baseband waveform, which are respectively a m+1^{th} first baseband waveform and a m+1^{th} second baseband waveform.

Without the presence of the second input 214, the modulated waveform either after the first modulation 206 or the second modulation 207 is output as a m^{th} first channel output 218 for driving the first power transistor and the modulated waveform either after the third modulation 208 or the fourth modulation 209 is output as a m^{th} second channel output 219 for driving the second power transistor.

With the presence of the second input 215, the modulated waveform either after the first modulation 206 or the second modulation 207 is blocked against outputting by a third switch 212 and the modulated waveform either after the third modulation 208 or the fourth modulation 209 is blocked against outputting by a fourth switch 217, instead the modulated waveform either after the first modulation 206 or the second modulation 207 after the first duty-adjusting 213 is output as a m^{th} first channel output 218 for driving the first power transistor and the modulated waveform either after the third modulation 208 or the fourth modulation 209 after the second duty-adjusting 216 is output as a m^{th} second channel output 219 for driving the second power transistor. A second “yes” 214 indicates the presence of the second input 215 is found.

The phase in the phase shifting 205 is not limited, for example, it ranges between 0 degree and 360 degree. With the presence of the Lenz current, the Lenz current is 180° phase-shifted by the phase-shifting 205 before being sent into the second modulation 207 and the fourth modulation 209.

The second controller has characterized that the first input 204 is a system responding signal such as Lenz current not for a given signal. As same as revealed in the first controller in FIG. 1, a “no Lenz current is detected after initiation and it is verified as a fault” 221 is seen in FIG. 2 to shut off the operation of the second controller for the consideration of safety.

Lenz current is a system responding signal, a reaction to its driving current, so that it should be there as long as the system functions normally. A fault can be detected if at any time an absence of the Lenz current is detected after a defined initiation of the second controller. When a fault is detected, immediately shut down the operation of the second controller for the consideration of safety by shutting off either the first baseband waveform 201, the second baseband waveform 202 and the high-frequency waveform 203 or shutting off the first modulation 206, the second modulation 207, the third modulation 208 and the fourth modulation 209. FIG. 2 has shown a “a fault is detected when no Lenz current is detected after a defined initiation” 221 to shut off the first baseband waveform 201, the second baseband waveform 202 and the high-frequency waveform 203 aiming to shut down the operation of the first controller. The defined initiation is not limited, for example, it can be a certain number running rounds of the flow chart shown in FIG. 2. The second controller for driving two power transistors has also revealed a fault detection technique by detecting the presence of Lenz current of a loop linking to the power transistors to function with.

The second input 215 is not limited, for example, it can be a signal from a sensor such as temperature sensor, voltage sensor, current sensor or chemical sensor, etc., a signal from an emergency procedure such as a “stop” command, a signal from a manual control such as a control manipulated by hand or foot or a control by a software.

1. A controller for driving a power transistor in a loop operated by steps for m≧1:
generating a m^{th} baseband waveform and generating a m^{th} high-frequency waveform;
checking if a presence of a first input;
if no presence of the first input is found, performing a m^{th} first modulation by modulating the m^{th} high-frequency waveform with the m^{th} baseband waveform; or
if the presence of the first input is found, phase-shifting the first input, and performing a m^{th} second modulation by modulating the m^{th} baseband waveform with the first input after the phase-shifting;
checking if a presence of a second input; and
if no presence of the second input, outputting the modulated waveform either after the m^{th} first modulation or the m^{th} second modulation as a m^{th} output for driving the power transistor; or
if the presence of the second input is found, adjusting a m+1^{th} baseband waveform, and duty-adjusting a duty cycle of the modulated waveform either after the m^{th} first modulation or the m^{th} second modulation, and outputting the modulated waveform after the duty-adjusting as a m^{th} output for driving the power transistor.

2. The controller for driving a power transistor in a loop operated by steps of claim 1, wherein the first input is a system responding signal.

3. The controller for driving a power transistor in a loop operated by steps of claim 1, wherein the second input is a signal from a sensor, a signal from an emergency procedure, a signal of a stop command, a signal from a manual control or a control by a software.

4. The controller for driving a power transistor in a loop operated by steps of claim 2, wherein the second input is a signal from a sensor, a signal from an emergency procedure, a signal from a manual control or a control by a software.

5. The controller for driving a power transistor in a loop operated by steps of claim 2, wherein the system responding signal is a Lenz current decoupled from the loop containing the power transistor and the phase-shifting is 180°-shifting.

6. The controller for driving a power transistor in a loop operated by steps of claim 4, wherein the system responding signal is a Lenz current decoupled from the loop containing the power transistor and the phase-shifting is 180°-shifting.

7. The controller for driving a power transistor in a loop operated by steps of claim 4, wherein the phase-shifting is between 0°^{˜}360° phase-shifting.

8. The controller for driving a power transistor in a loop operated by steps of claim 6, wherein a fault is detected if at any time an absence of the Lenz current is detected after a defined initiation.

9. The controller for driving a power transistor in a loop operated by steps of claim 8, wherein either the m^{th} first modulation and the m^{th} second modulation or the m^{th} baseband waveform and the m^{th} high-frequency waveform are shut off to shut down the operation of the first controller.

10. The controller for driving a power transistor in a loop operated by steps of claim 8, wherein a Miller effect of the driven power transistor is cancelled.

11. A controller for driving a first power transistor and a second power transistor in a loop operated by steps for m≧1:
generating a m^{th} first baseband waveform, and generating a m^{th} second baseband waveform, and generating a m^{th} high-frequency waveform;
checking if a presence of a first input;
if no presence of the first input is found, performing a m^{th} first modulation by modulating the m^{th} high-frequency waveform with the m^{th} first baseband waveform, and performing a m^{th} third modulation by modulating the m^{th} high-frequency waveform with the m^{th} second baseband waveform; or
if the presence of the first input is found, phase-shifting the first input, and performing a m^{th} second modulation by modulating the m^{th} first baseband waveform with the first input after the phase-shifting, and performing a m^{th} fourth modulation by modulating the m^{th} second baseband waveform with the first input after the phase-shifting;
checking if a presence of a second input; and
if no presence of the second input is found, outputting the modulated waveform either after the m^{th} first modulation or the m^{th} second modulation as a m^{th} first channel output for driving the first power transistor, and outputting the modulated waveform either after the m^{th} third modulation or the m^{th} fourth modulation as a m^{th} second channel output for driving the second power transistor; or
if the presence of the second input is found, adjusting a m+1^{th} first baseband waveform and a m+1^{th} second baseband waveform, and duty-adjusting a duty cycle of the modulated waveform either after the m^{th} first modulation or the m^{th} second modulation as a first dutyadjusting, and duty-adjusting a duty cycle of the modulated waveform either after the m^{th} third modulation or the m^{th} fourth modulation as a second duty-adjusting, and outputting the modulated waveform after the first duty-adjusting as a m^{th} first channel output for driving the first power transistor and outputting the modulated waveform after the second duty-adjusting as a m^{th} second channel output for driving the second power transistor.

12. The controller for driving a first power transistor and a second power transistor in a loop operated by steps of claim 11, wherein the first input is a system responding signal.

13. The controller for driving a first power transistor and a second power transistor in a loop operated by steps of claim 11, wherein the second input is a signal from a sensor, a signal from an emergency procedure, a signal of a stop command, a signal from a manual control or a control by a software.

14. The controller for driving a first power transistor and a second power transistor in a loop operated by steps of claim 12, wherein the second input is a signal from a sensor, a signal from an emergency procedure, a signal from a manual control or a control by a software.

15. The controller for driving a first power transistor and a second power transistor in a loop operated by steps of claim 12, wherein the system responding signal is a Lenz current decoupled from the loop containing the power transistor and the phase-shifting is 180°-shifting.

16. The controller for driving a first power transistor and a second power transistor in a loop operated by steps of claim 14, wherein the system responding signal is a Lenz current decoupled from the loop containing the power transistor and the phase-shifting is 180°-shifting.

17. The controller for driving a first power transistor and a second power transistor in a loop operated by steps of claim 14, wherein the phase-shifting is between 0°^{˜}360° phase-shifting.

18. The controller for driving a first power transistor and a second power transistor in a loop operated by steps of claim 16, wherein a fault is detected if at any time an absence of the Lenz current is detected after a defined initiation.

19. The controller for driving a first power transistor and a second power transistor in a loop operated by steps of claim 18, wherein either the m^{th} first modulation and the m^{th} second modulation or the m^{th} baseband waveform and the m^{th} high-frequency waveform are shut off to shut down the operation of the first controller.

20. The controller for driving a first power transistor and a second power transistor in a loop operated by steps of claim 18, wherein a Miller effect of the driven power transistor is cancelled.

21. The controller for driving a power transistor in a loop operated by steps of claim 8, wherein the signal from the emergency procedure includes to stop generating a m+1^{th} baseband waveform and to stop generating a m+1^{th} high-frequency waveform to shut down the operation of the controller.

22. The controller for driving a first power transistor and a second power transistor in a loop operated by steps of claim 18, wherein the signal from the emergency procedure includes to stop generating a m+1^{th} first baseband waveform, to stop generating a m+1^{th} second baseband waveform and to stop generating a m+1^{th} high-frequency waveform to shut down the operation of the controller.
